(19) United States
(12) Patent Application Publication
(10) Pub. No.: US 2002/0147621 A1
(43) Pub. Date: Oct. 10, 2002

(54) Multiple donor/recipient donation system and business method

(76) Inventor: Guy H. Smith III, Alameda, CA (US)

Correspondence Address: Guy H. Smith, 630 Taylor Ave, Alameda, CA, 94501, US

(21) Appl. No.: 09/828,244

(22) Filed: Apr. 9, 2001

(51) Int. Cl. G06F 17/60

(52) U.S. Cl. 705/7

(57) ABSTRACT

An automated method for allowing one or more donors to make periodic donations to one or more organizations with a single payment for each period, and to communicate requests for action to said organizations. The method accepts personal information from donors, including information necessary to collect their donations. The method allows donors to select one or more organizations to donate to, and to specify a specific amount to donate to each. The method aggregates donations, and collects from the donor once for the total of their donations on a periodic basis. The method aggregates collected donations on a periodic basis to facilitate payment of collected donations to all organizations to which donors have donated during the period. The method also allows donors to communicate requests for actions to organization that the donors contribute.

### CROSS-REFERENCE TO RELATED APPLICATIONS

Not applicable.

### FEDERAL R&D REQUIREMENTS

Not applicable.

### BACKGROUND

1. Field of the Invention

This invention relates to the business method and automation of managing donations by individual donors and performing related services in connection with their donations.

2. Prior Art

Traditional fund raising for non-profit organizations has had two primary characteristics: Funds are raised during periodic campaigns, and funds are raised by the organization approaching individual donors and soliciting donations, most often through mass-mail campaigns. These approaches are expensive for the organization, and fail to address common desires of donors.

Small donors fail to donate as much as they could due to limitation inherent in common fundraising methods. The disadvantages to donors of current methods include:

Inability to budget donations

Inability to provide to all the organizations they deem worthwhile

The tedium of responding to mail fundraising campaigns and writing many checks

The difficulty and embarrassment of writing checks for small amounts that their budgets require

The lack of anonymity in responding to fundraising or by writing checks to organizations

The disadvantages for non-profit organizations include:

The expense of fundraising campaigns depletes funds available for the organization's mission

The data processing burden of maintaining and expanding fundraising mailing lists

Staff time required to manage fundraising activities and respond to donor's problems within the fundraising process

Uncertainty of income from donations

Some charities have made minor attempts at using Internet technologies to facilitate donations. However, these have largely been single payment systems that require the donor to make repeat visits to donate periodically. One non-profit organization does offer an Internet based subscription service, but this funds only their organization.

Several 3^{rd} party companies have entered the business of channeling donations, but they offer no more service than one would receive by visiting the sites of the recipient organizations. None offer a subscription service, and none provide for one payment to be divided among multiple organizations. Additionally, none offer services to the donor to aid with common or recurring requests for action on the part of the recipient organization, such as asking for a tax receipt.

### SUMMARY

This invention provides significant flexibility for donors in selecting, funding, and communicating requests to organizations of their choosing. It overcomes the shortcomings set forth above. It also provides organizations with predictable sources of funding with no fundraising expenses.

### OBJECTS AND ADVANTAGES

Accordingly, several objects and advantages of my invention are:

(A) Provides donors with the ability to automatically make monthly contributions.

(B) Allows donors to easily budget donations.

(C) Provides donors with the ability to divide their contribution between multiple organizations if desired.

(D) Provides donors the ability to have one personal financial transaction fund multiple organizations.

(E) Provides donors with the ability to change the amount of their donations, and the organizations to which they donate, at any time.

(F) Provides anonymity to the donor if so desired.

(G) Removes psychological and functional barriers to making small donations.

(H) Provides donations to organizations without said organizations spending money on fundraising activities.

(I) Provides organizations with a steady and predictable stream of donations.

Further objects and advantages of my invention will become apparent from the consideration of the drawings and ensuing descriptions.

### DRAWINGS, FIGURES

Table 1: Subscriber information database table: List of relevant fields for a database table recording information about donors (subscribers).

Table 2: Organization information database table: List of relevant fields for a database table recording information about organizations that can receive donations. Includes both information presented to subscribers and for backoffice operations.

Table 3: Subscribers donation requests: List of relevant fields for a database table recording each donation from each donor for each organization they elect to fund.

Table 4: Repository for successful donations: List of relevant fields for a database table recording every successful donation (i.e., monies successfully collected from donor) from every subscriber for every organization they elect to fund.

Table 5: Record of payouts to organizations: List of relevant fields for a database table recording when the invention forwards payments and requests from donors to recipient organizations.

FIG. 1: Flowchart for processing subscriber registration.

FIG. 2: Example registration screen: Show a screen designed to accept personal information from donor (subscriber).

FIG. 3: Flowchart showing process for subscriber to define their contributions to organizations and request either or both removal from their fundraising lists and a tax receipt.

FIG. 4: Example selection of recipient organization

FIG. 5: Example contribution summary

FIG. 6: Flowchart for nightly billing process to charge subscribers and record donations made to organizations.

FIG. 7: Flowchart for periodic aggregations of donations made by subscribers to organizations, and creates necessary files for communicating subscriber requests.

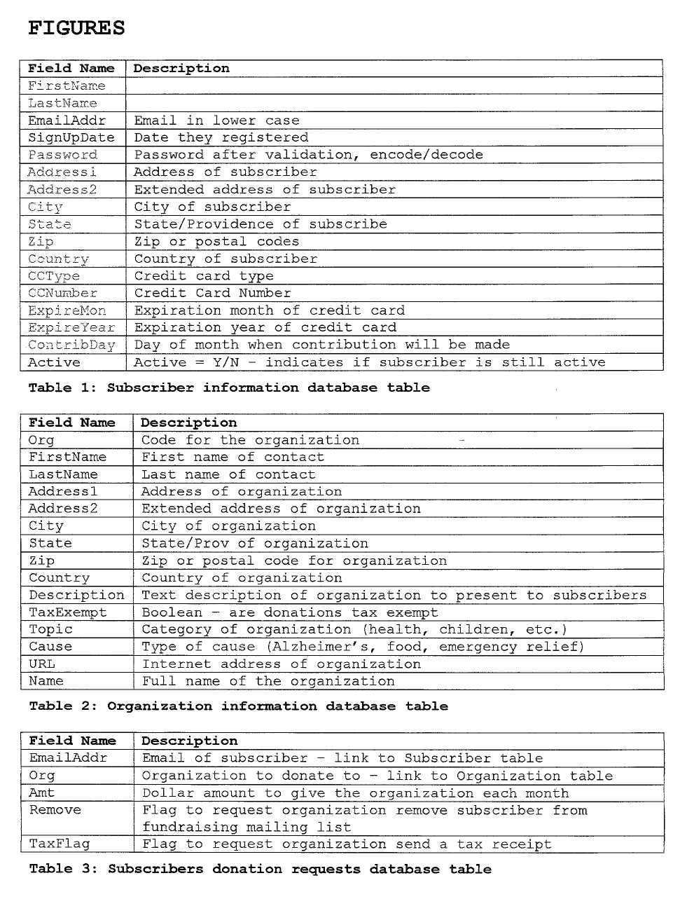

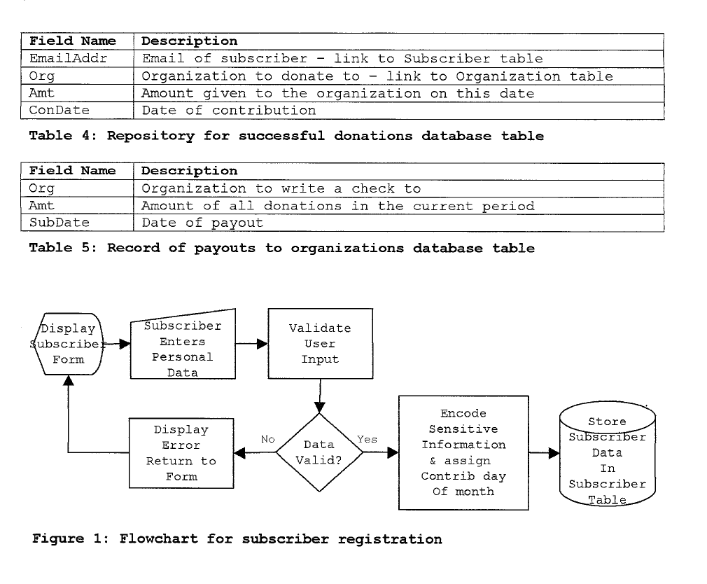

### DESCRIPTION OF INVENTION

The invention can be built on any application specific or general-purposecomputing platform that supports an on-line capable database and a means for presenting information to, and collecting input from single or multiple donors. Any suitable programming language can be used that has programmatic access to the database and can be executed from the user interface. The prototype implementation of this invention used a PC running Linux OS, the Apache HTTP server, mySQL database, and the PERL scripting language. The invention is not limited to any or all of these components or presentation (HTML) methods, products or tools.

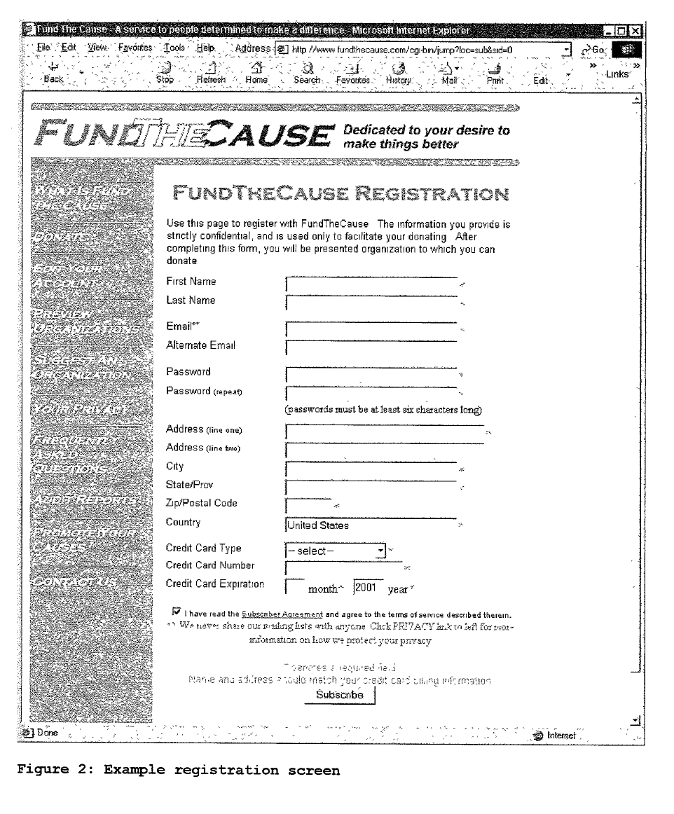

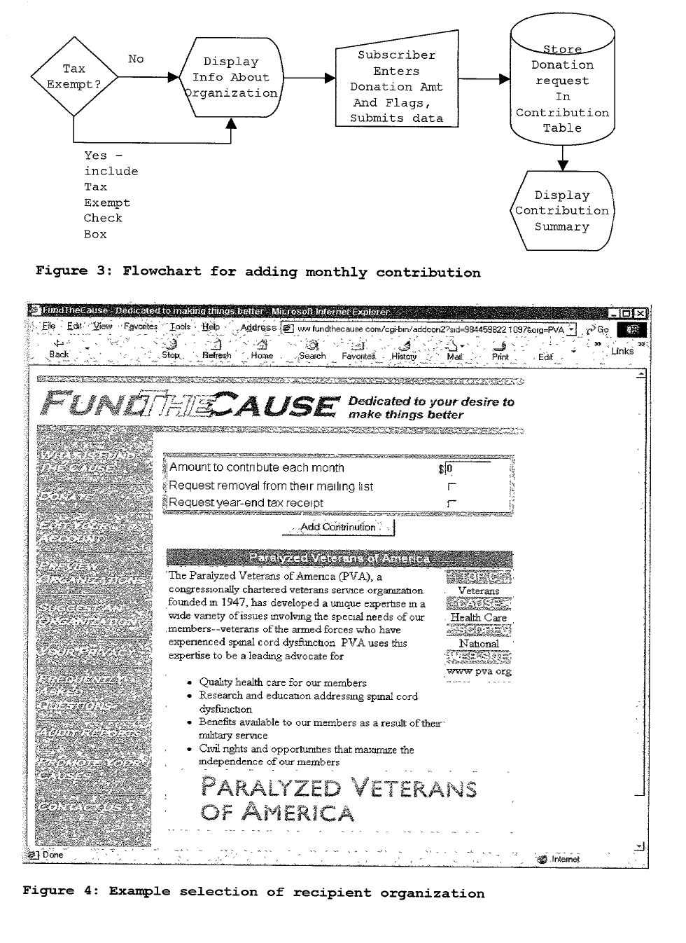

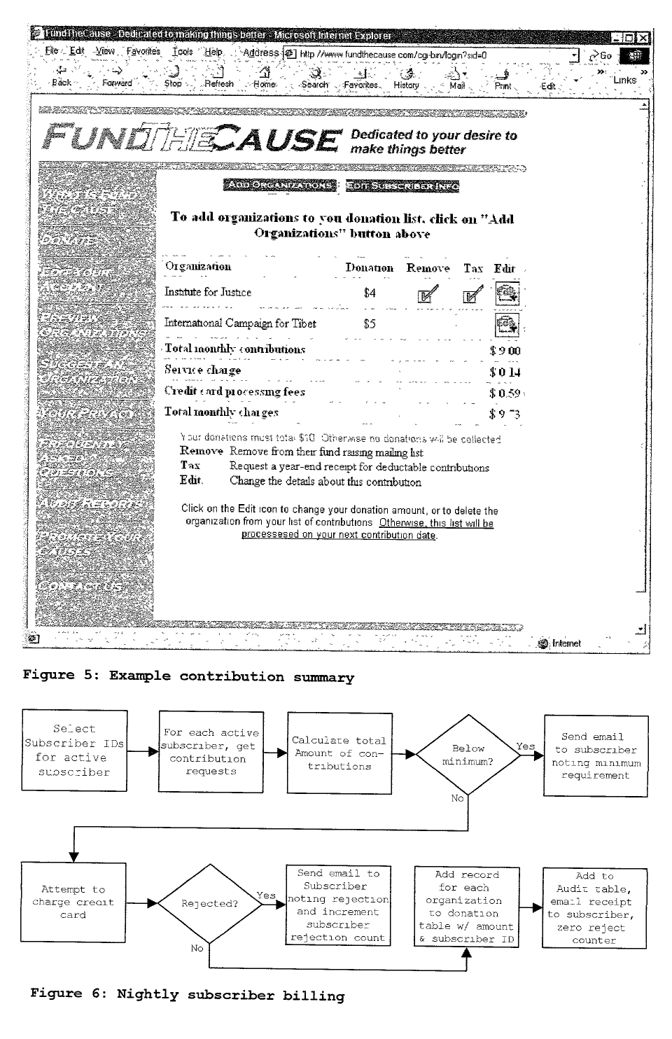

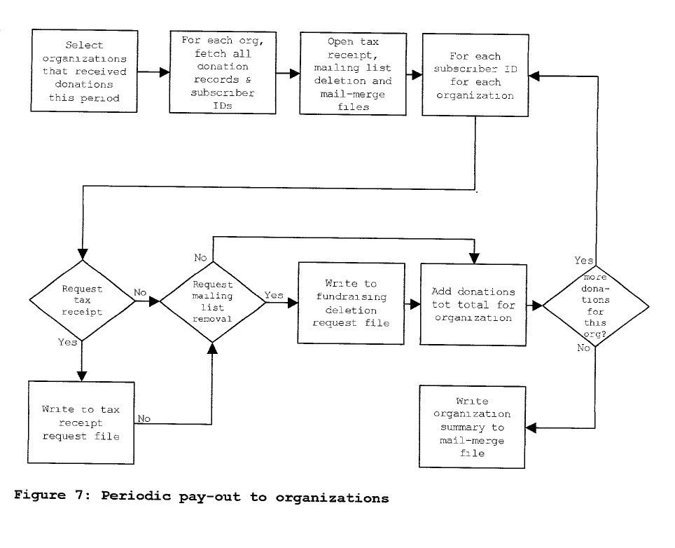

Step 1—subscriber registration: The process begins when a donor (subscriber) decides to employ the invention as a service to manage their donations. The subscriber enters personal information in an on-line screen (FIG. 2). Upon submitting the form, the invention validates all critical fields, and ensures passwords are entered correctly. If any data is invalid, the errors are noted and the user is returned to the form. Otherwise, sensitive information is encrypted and all fields are inserted into the subscriber information table. The invention assigns a number between 1 and 28 that will be the day of the month on which the subscriber will be billed for all their donations. This is added to the table as well.

Step 2—selection of recipient organizations: Once registered, subscribers use the invention to select organizations to which they wish to donate. Organization information is held in a separate table within the on-line database (Table 2). The user is presented a list of the organizations. The format or process of presentation of the list of organizations is irrelevant to the invention.

Subscribers review any, some, or all organizations (though presented herein as a “one at a time” process, the invention includes the ability to present packages of recipient organizations, or other combinations). For any of the organizations, the user is presented details for said organizations (FIG. 4). The subscriber is given text concerning the mission of the organization, the scope of their influence (international, national, state), the categories they belong to, and their web site address (the limits of information show in this example do not limit the scope of information presentable by the invention and should not be considered a limitation of the patent).

For each organization, the subscriber is offered a form to define what their monthly contribution will be. This can be in any denomination to suit specific nationalities (in the example in FIG. 4, I use U.S. dollars, but the invention is designed to facilitate localized implementations for any country or region). For each organization, a check box is offered to allow the subscriber to request that they be removed from fundraising lists for that specific organization. If the record for the organization in the organization table (Table 2) indicates that donations are tax-exempt, a check box is presented allowing the subscriber to request a tax receipt for their donation. This check box is not presented if donations are not tax exempt for that organization.

When the subscriber commits to donating to an organization (by clicking on the “Add Contribution” button), the subscriber ID, organization code, amount of contribution, and the removal and tax-exempt requests are added to the monthly donation table (Table 3). If a record for the same subscriber ID and organization code exists, the existing record is overwritten (effectively updating the record).

Step 3—perodic donation processing: The invention executes a batch process¹ to bill customers and confirm donations (FIG. 6). Once each day (though the period is configurable), up to and including the 28^{th} of each month, this process (job) is executed. ¹“Batch process” defines a computer program that runs without human interaction, often launched using scheduling software.

The job selects all subscribers IDs from the subscriber table (Table 1) that have a contribution day of the current day of the month. The job then selects from the contribution table (Table 3) all records for each of the subscribers, processing one subscriber ID at a time.

For each subscriber ID, the job calculates the total amount of the subscriber's donations. The job adds to this the service fee and the credit card processing charges (the use of credit cards in this example does not limit the inventions scope on the methods of collecting money from subscribers, and can be adapted for other methods such as traditional paper bills sent through the postal service). If the total of their donations is less than a configurable minimum, an email noting so is sent to the donor and the job continues with the next subscriber ID. Otherwise, the job attempts to electronically charge the subscriber's credit card for the sum of their donations, fees and service charges.

If the charge is rejected from the credit card processing service, an email is sent to the subscriber noting the rejection and the reason cited by the credit card processing company. The reject counter for the subscriber ID in the subscriber table (Table 1) is incremented. If the reject counter reaches a configurable number, the subscriber will be considered inactive and no future attempt will be made to process their donations, and the subscriber will be notified of the discontinuation of service.

If the charge is accepted, the following happens: First, a record for each organization the donor is funding is written to the donation repository table (Table 4). This information includes the subscriber ID, the organization code and the amount of the donation. A record in this table indicates a successful donation requiring a future payment to the organization from this system. Next, an email is sent to the subscriber detailing all of his contributions.

Step 4—periodic payout processing: This batch process (job) examines all successful donation records (Table 4) for a range of dates (typically the previous quarter, but any range could be used). From this query, the job determines the amount of money to send to each organization, and builds files to facilitate automatic creation of transmittal letters. The job also creates files containing information about subscribers that for each organization have requested tax receipts or to be removed from fundraising lists the organization may maintain.

The job selects from the successful donation table (Table 4) the organization code for all organizations that have received donations during the period. For each organization code, the job performs the following steps.

First, the job gathers records from the successful donation table (Table 4) containing the subscriber ID, donation amount, and action request flags for all successful donations for that organization and for the date range. The job scans all records and calculates the total of all donations. For each subscriber ID, the job looks up the contribution definition record (Table 3) and determines if the subscriber has requested either fundraising list removal or a tax receipt. If either has been requested, the job opens an associated disc file (if not already open) and writes a record containing all relevant subscriber information to that file.

Once all donation records have been processed, a record is written to a separate file containing contact information for the organization (drawn from table 2) and the total amount of all donations for that organization for the period. The disc file is formatted such that is can be used by common, commercially available mail-merge software to create transmittal letters to accompany checks and diskettes with the tax-exempt and removal requests records.

### CONCLUSION, RAMIFICATIONS AND SCOPE

The reader will notice that the invention offers a significant level of previously unavailable convenience and flexibility to donors, especially donors with modest budgets. The invention also provides a significant benefit to recipient organizations in reducing their costs for raising funds and improving relations with donors.

While the above description shows many specifications, these should not be construed as limitations on the scope of the invention, but rather as an exemplification of one preferred embodiment. Many other variations are possible with only minor changes in software implementations. For example, efficiencies in batch processing can be achieved with different orderings of database operations, or other requests for service (akin to the requests for tax receipts and removal from mailing lists) are easily added. Yet variations and extensions do not alter the fundamental advantages and process of the invention.

Accordingly, the scope of this invention should be determined not by the embodiment(s) illustrated, but by the appended claims and their legal equivalents.

I claim:

1. A method for facilitating donations from one or more donors to one or more organizations comprising:
a) A means for registering donors,
b) A means for allowing donors to select organization(s) to donate to,
c) A means for specifying an amount to donate to each selected organization on a periodic basis,
d) A means for collecting money from donors on a periodic basis based on their said specified donations
e) A means for calculating the sum of all donations for each organization
f) A means for reporting to said organizations the amount of the donations to said organizations from said donors,
g) Whereby donors can make periodic donations to one or many organizations with a single payment.
I claim as dependent upon the main claim (claim 1):

2. A method for communicating requests for action from said donors to said organizations for which they donate comprising:
a) A means for allowing said donors to specify the action to be requested,
b) A means to report to said organizations necessary information about said donors,
c) A means for eliminating redundant reporting of information about said donors to said organizations (i.e., to prevent multiple request records during a single reporting period).

3. A method for counting the number or rejected billing attempts against said donors to identify and notify inactive donors.

4.

5. A means for subscribers to terminate the donations.
